(19) United States
(12) Patent Application Publication
(10) Pub. No.: US 2024/0205975 A1
(43) Pub. Date: Jun. 20, 2024

(54) WIRELESS COMMUNICATION METHOD, FIRST DEVICE, AND SECOND DEVICE

(71) Applicant: GUANGDONG OPPO MOBILE TELECOMMUNICATIONS CORP., LTD., Dongguan (CN)

(72) Inventors: Nande ZHAO, Dongguan (CN); Dongjun MA, Singapore (CN)

(73) Assignee: GUANGDONG OPPO MOBILE TELECOMMUNICATIONS CORP., LTD., Dongguan (CN)

(21) Appl. No.: 18/592,370

(22) Filed: Feb. 29, 2024

Related U.S. Application Data
(63) Continuation of application No. PCT/CN2021/129047, filed on Nov. 5, 2021.

(51) Int. Cl. H04W 74/0816; H04W 16/28; H04W 74/08

(52) U.S. Cl. CPC H04W 74/0816; H04W 16/28; H04W 74/0866

(57) ABSTRACT

A wireless communication method, a first device, and a second device are provided. In the method, under the condition that a gap between two adjacent transmissions within a channel occupancy time (COT) is greater than or equal to a first gap, before the second one of the two adjacent transmissions is performed, category 2 Listen Before Talk (Cat 2 LBT) is performed. Here, the first gap includes a first maximum gap and/or a second maximum gap, the first maximum gap is a maximum gap without data transmission on all beams within the COT, and the second maximum gap is a maximum gap without data transmission on one beam within the COT. The second transmission is resumed based on the execution result of the Cat 2 LBT.

### CROSS-REFERENCE TO RELATED APPLICATION

This application is a continuation of International Patent Application No. PCT/CN2021/129047 filed on Nov. 5, 2021, disclosure of which is hereby incorporated by reference in its entirety.

### BACKGROUND

So far, for unlicensed frequency bands, transmission within Channel Occupancy Time (COT) may be resumed by the transmission resuming mechanism of the COT. Specifically, after the gap, which is between two transmissions within the COT of an initiating device that initiates COT detection, is greater than the maximum gap, the initiating device may resume the transmission within the COT by Category 2 (Cat 2) Listen Before Talk (LBT). In other words, in the transmission resuming mechanism of the COT, the maximum gap is defined based on the existence of the transmission on the initiating device. The initiating device may determine, by the maximum gap defined based on the existence of the transmission on the initiating device, whether to perform the Cat 2 LBT before the transmission within the COT is resumed.

However, the initiating device may communicate with multiple responding devices. Therefore, if the maximum gap is defined based on only the existence of the transmission on the initiating device, transmission between the initiating device and all of the responding devices is resumed within the COT, or transmission between the initiating device and all of the responding devices is not resumed within the COT, which reduces the resuming effect of transmission resuming.

Therefore, there is an urgent need in the field for a wireless communication method to improve the resuming effect of transmission resuming based on reducing the complexity of transmission resuming.

### SUMMARY

Embodiments of the disclosure provide a wireless communication method, a first device, and a second device. The method provided by the disclosure may not only reduce the complexity of transmission resuming, but also improve the resuming effect of transmission resuming.

In a first aspect, the disclosure provides a wireless communication method, including the following operations. When a gap between two neighboring transmissions within COT is greater than or equal to a first gap, Cat 2 LBT is performed before a last transmission of the two neighboring transmissions is performed. Here, the first gap includes a first maximum gap and/or a second maximum gap, the first maximum gap is a maximum gap, in which none of beams has data transmission, within the COT, and the second maximum gap is a maximum gap, in which one beam has no data transmission, within the COT. The last transmission is resumed based on a performing result of the Cat 2 LBT.

In a second aspect, the disclosure provides a wireless communication method, including the following operations. When a gap, which is between a transmission of a first device within Channel Occupancy Time (COT) and a transmission of the second device when the COT is shared, is greater than or equal to a second maximum gap, Category 2 Listen Before Talk (Cat 2 LBT) is performed before the transmission of the second device is performed. Here, the transmission of the first device is a transmission on a beam corresponding to the second device within the COT, and the second maximum gap is a maximum gap, in which one beam has no data transmission, within the COT. The transmission of the second device is performed based on a performing result of the Cat 2 LBT.

In a third aspect, the disclosure provides a first device including a processor and a memory. The memory is configured to store a computer program, and the processor is configured to call and run the computer program stored in the memory, to perform operations of: when a gap between two neighboring transmissions within Channel Occupancy Time (COT) is greater than or equal to a first gap, performing Category 2 Listen Before Talk (Cat 2 LBT) before a last transmission of the two neighboring transmissions is performed; wherein the first gap comprises a first maximum gap and/or a second maximum gap, the first maximum gap is a maximum gap, in which none of beams has data transmission, within the COT, and the second maximum gap is a maximum gap, in which one beam has no data transmission, within the COT; and resuming the last transmission based on a performing result of the Cat 2 LBT.

In a fourth aspect, the disclosure provides a second device including a processor and a memory. The memory is configured to store a computer program, and the processor is configured to call and run the computer program stored in the memory, to perform operations of: when a gap, which is between a transmission of a first device within Channel Occupancy Time (COT) and a transmission of the second device when the COT is shared, is greater than or equal to a second maximum gap, performing Category 2 Listen Before Talk (Cat 2 LBT) before the transmission of the second device is performed; wherein the transmission of the first device is a transmission on a beam, which corresponds to the second device, within the COT, and the second maximum gap is a maximum gap, in which one beam has no data transmission, within the COT; and performing the transmission of the second device based on a performing result of the Cat 2 LBT.

### BRIEF DESCRIPTION OF THE DRAWINGS

FIG. 1 is an example of an application scenario of the disclosure.

FIG. 2 is a schematic flowchart of a wireless communication method provided by an embodiment of the disclosure.

FIG. 3 is a schematic diagram of not resuming transmission within COT by the maximum gap corresponding to all beams within the COT, which is provided by an embodiment of the disclosure.

FIG. 4 is a schematic diagram of resuming transmission within COT by the maximum gap corresponding to all beams within the COT, which is provided by an embodiment of the disclosure.

FIG. 5 is another schematic diagram of resuming transmission within COT by the maximum gap corresponding to all beams within the COT, which is provided by an embodiment of the disclosure.

FIG. 6 is a schematic diagram of not resuming transmission within COT by the maximum gap in which one beam has no data transmission within the COT, which is provided by an embodiment of the disclosure.

FIG. 7 is a schematic diagram of resuming transmission within COT by the maximum gap in which one beam has no data transmission within the COT, which is provided by an embodiment of the disclosure.

FIG. 8 is a schematic diagram of preforming Cat 2 LBT by each to-be-resumed beam when transmission within COT is resumed by the maximum gap in which one beam has no data transmission within the COT, which is provided by an embodiment of the disclosure.

FIG. 9 is a schematic diagram of preforming Cat 2 LBT by a beam covering multiple to-be-resumed beams when transmission within COT is resumed by the maximum gap in which one beam has no data transmission within the COT, which is provided by an embodiment of the disclosure.

FIG. 10 is a schematic diagram of resuming transmission within COT by the maximum gap corresponding to all beams within the COT and the maximum gap in which one beam has no data transmission within the COT simultaneously, which is provided by an embodiment of the disclosure.

FIG. 11 is another schematic flowchart of a wireless communication method provided by an embodiment of the disclosure.

FIG. 12 is a schematic diagram of resuming transmission of a second device when COT is shared by the maximum gap in which one beam has no data transmission within the COT, which is provided by an embodiment of the disclosure.

FIG. 13 is a schematic block diagram of a first device provided by an embodiment of the disclosure.

FIG. 14 is a schematic block diagram of a second device provided by an embodiment of the disclosure.

FIG. 15 is a schematic block diagram of a communication device provided by an embodiment of the disclosure.

FIG. 16 is a schematic block diagram of a chip provided by an embodiment of the disclosure.

### DETAILED DESCRIPTION

The technical solutions in the embodiments of the disclosure will be described below in combination with the drawings in the embodiments of the disclosure. It is apparent that the described embodiments are a part of the embodiments of the disclosure and not all of the embodiments. Based on the embodiments of the disclosure, all other embodiments obtained by those of ordinary skill in the art without making creative labor fall within the scope of protection of the disclosure.

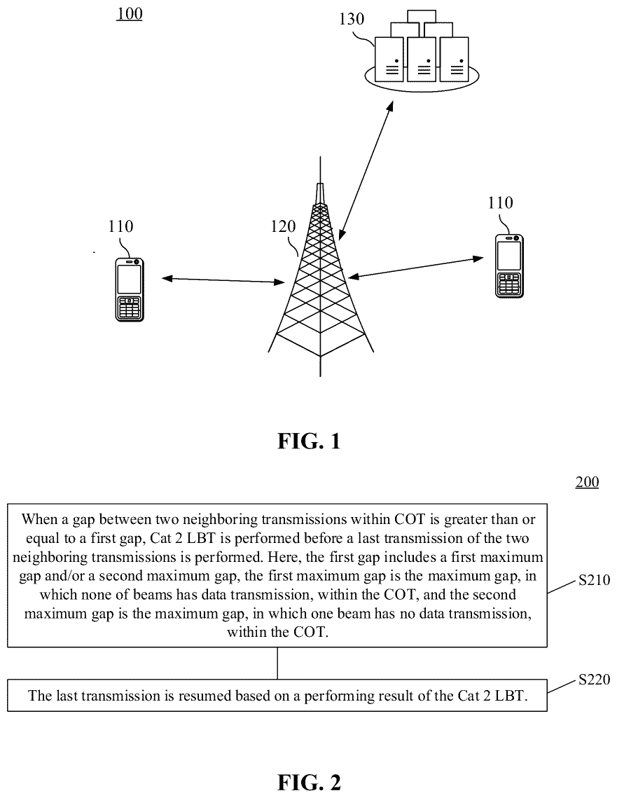

FIG. 1 is a schematic diagram of an application scenario of an embodiment of the disclosure.

As shown in FIG. 1, the communication system 100 may include a terminal device 110 and a network device 120. The network device 120 may communicate with the terminal device 110 through an air interface. Multi-service transmission is supported between the terminal device 110 and the network device 120.

It is to be understood that the embodiments of the disclosure are only illustrated exemplarily with the communication system 100, but the embodiments of the disclosure are not limited thereto. In other words, the technical solutions of the embodiments of the disclosure may be applied to various communication systems, for example, a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, a LTE Time Division Duplex (TDD), a Universal Mobile Telecommunication System (UMTS), a Worldwide Interoperability for Microwave Access (WiMAX) communication system, a New Radio (NR), or a future 5G system.

Taking the 5G system as an example, the technical solutions of the embodiments of the disclosure may be applied to wide-area Long Term Evolution (LTE) coverage and the island coverage mode of NR. Moreover, a large amount of LTE is deployed below 6 GHz, and there are few spectrums below 6 GHz available for 5G. Therefore, NR must study spectrum applications above 6 GHz, while the high-frequency band has limited coverage and fast signal fading. Furthermore, in order to protect investment of mobile operators in LTE in the early stage, a working mode of tight interworking between LTE and NR is proposed.

Main application scenarios of 5G include: Enhance Mobile Broadband (eMBB), Ultra-Reliable and Low Latency Communication (URLLC), and massive machine type of communication (mMTC). eMBB aims to enable the user to obtain multimedia content, services, and data, and its demand is growing very rapidly. eMBB may be deployed in different scenarios, for example, indoor, urban area, rural area, or the like, and the difference in capability and demand is large, which thus cannot be generalized, and may be analyzed in detail with specific deployment scenarios. Typical applications of URLLC include: industrial automation, electric power automation, telemedicine operations (surgeries), traffic safety security, or the like. Typical characteristics of mMTC include: high connection density, small data volume, delay-insensitive services, low cost and long lifetime of modules, or the like.

Furthermore, since complete 5G NR coverage is difficult to obtain, the network coverage of the embodiments of the disclosure may adopt wide-area Long Term Evolution (LTE) coverage and the island coverage mode of NR. Furthermore, in order to protect investment of mobile operators in LTE in the early stage, a working mode of tight interworking between LTE and NR may further be adopted.

In the communication system 100 shown in FIG. 1, the network device 120 may be an access network device that communicates with the terminal device 110. The access network device may provide communication coverage for a specific geographic region and may communicate with a terminal device 110 (for example, a UE) located within the coverage area.

Optionally, the network device 120 may be a Base Transceiver Station (BTS) in a Global System of Mobile communication (GSM) system or Code Division Multiple Access (CDMA), or a NodeB (NB) in a Wideband Code Division Multiple Access (WCDMA) system. The network device 120 may also be an Evolutional Node B (eNB or eNodeB) in a Long Term Evolution (LTE) system. Optionally, the network device 120 may also be a base station (gNB) in a Next Generation Radio Access Network (NG RAN) or in an NR system, or a radio controller in a Cloud Radio Access Network (CRAN). Alternatively, the access network device may be a relay station, an access point, an on-board device, a wearable device, a hub, a switch, a bridge, a router, a network device in a future evolved Public Land Mobile Network (PLMN), or the like.

Optionally, the terminal device 110 may be any terminal device, which includes, but not limited to: a device connected through a wired line, such as through Public Switched Telephone Networks (PSTN), a Digital Subscriber Line (DSL), a digital cable, or a direct cable; and/or, a device through another data connection/network; and/or, a device through a wireless interface, for example, a cellular network, a Wireless Local Area Network (WLAN), a digital television network such as a DVB-H network, a satellite network, or an AM-FM radio transmitter; and/or, an apparatus of another terminal device, which is configured to receive/send communication signals; and/or, an Internet of Things (IoT) device. A terminal device configured to communicate through a wireless interface may be referred to as a “wireless communication terminal”, a “wireless terminal”, or a “mobile terminal”. Examples of mobile terminals include, but are not limited to: a satellite or a cellular telephone; a Personal Communications System (PCS) terminal that may combine a cellular radiotelephone with data processing, facsimile, and data communication function; a PDA that may include a radiotelephone, a pager, an Internet/Intranet access, a Web browser, a notebook, a calendar, and/or a Global Positioning System (GPS); conventional laptop and/or handheld receiver, and other electronic apparatuses including radiotelephone transceivers. The terminal device may refer to an access terminal, a User Equipment (UE), a user unit, a user station, a mobile station, a remote station, a remote terminal, a mobile device, a user terminal, a terminal, a wireless communication device, a user agent, or a user apparatus. The access terminal may be a cellular telephone, a cordless telephone, a Session Initiation Protocol (SIP) telephone, a Wireless Local Loop (WLL) station, a Personal Digital Assistant (PDA), a handheld device or a computing device with a wireless communication function, or other processing devices connected to a wireless modem, an on-board device, a wearable device, a terminal device in 5G network, a terminal device in a future evolved PLMN, or the like.

Optionally, Device to Device (D2D) communication may be performed between terminal devices 110.

The wireless communication system 100 may further include a core network device 130 that communicates with a base station. The core network device 130 may be a 5G Core (5GC) device, such as an Access and Mobility Management Function (AMF), an Authentication Server Function (AUSF), a User Plane Function (UPF), or a Session Management Function (SMF). Optionally, the core network device 130 may also be an Evolved Packet Core (EPC) device of LTE network, for example, a Session Management Function+Core Packet Gateway (SMF+PGW-C) device. It is to be understood that the SMF+PGW-C is able to realize functions that may be realized by the SMF and the PGW-C at the same time.

Optionally, communication may be realized between various functional units in the communication system 100 by establishing a connection through a next generation (NG) interface.

For example, the terminal device establishes an air interface connection with the access network device through an NR interface for transmitting user plane data and control plane signaling. The terminal device may establish a control plane signaling connection with the AMF through NG interface 1 (N1 for short). The access network device, such as a next-generation wireless access base station (gNB), may establish a user plane data connection with the UPF through NG interface 3 (N3 for short). The access network device may establish a control plane signaling connection with the AMF through NG interface 2 (N2 for short). The UPF may establish a control plane signaling connection with the SMF through NG interface 4 (N4 for short). The UPF may exchange user plane data with a data network through NG interface 6 (N6 for short). The AMF may establish a control plane signaling connection with the SMF through NG interface 11 (N11 for short). The SMF may establish a control plane signaling connection with the PCF through NG interface 7 (N7 for short). It is to be noted that the part shown in FIG. 2 is only an exemplary architecture diagram, and in addition to the functional units shown in FIG. 1, the network architecture may further include other functional units or functional entities, for example, the core network device may further include other functional units such as a unified data management (UDM), which is not specifically limited by the embodiments of the disclosure.

FIG. 1 exemplarily illustrates a base station, a core network device, and two terminal devices. Optionally, the wireless communication system 100 may include multiple base station devices, and other numbers of terminal devices may be included within the coverage area of each base station, which is not limited by the embodiments of the disclosure.

It is to be understood that devices in the network/system in the embodiments of the disclosure, which have a communication function, may all be referred to as communication devices. Taking the communication system 100 shown in FIG. 1 as an example, the communication device may include a network device 120 and a terminal device 110 which have a communication function, and the network device 120 and the terminal device 110 may be the devices described above, which will not be repeated here. The communication device may further include other devices in the communication system 100, such as a network controller, a mobile management entity, or other network entities, which is not limited by the embodiments of the disclosure.

It is to be understood that the terms “system” and “network” may often be used interchangeably herein. The term “and/or” herein is only a description of an association relationship of associated objects, representing that there may be three kinds of relationships. For example, A and/or B may represent three conditions: i.e., independent existence of A, existence of both A and B and independent existence of B. Furthermore, the character “/” herein usually represents that the previous and next associated objects are in an “or” relationship.

The method provided by the disclosure applies to the unlicensed spectrum. The unlicensed spectrum is a spectrum divided by countries and regions that may be used for communication of radio devices, which is usually considered as a shared spectrum, that is, communication devices in different communication systems may use the spectrum as long as the communication devices satisfy the regulatory requirements set on the spectrum by countries and regions, and do not need to apply for a proprietary spectrum license from the government. For example, in some regions, communication devices follow the principle of “listen first and speak later”, that is, before sending signals on a channel of the unlicensed spectrum, a communication device needs to perform channel listening first. The communication device may send signals only when the channel listening result is that the channel is free, and the communication device cannot send signals when the channel listening result of the communication device on the channel of the unlicensed spectrum is that the channel is busy. With the development of wireless communication technology, both LTE systems and NR systems consider deploying networks on the unlicensed spectrum, in order to utilize the unlicensed spectrum for transmission of data services.

The method provided by the disclosure applies to high-frequency licensed frequency bands, such as 52.6 GHz-71 GHz.

Of course, in other alternative embodiments, the method provided by the disclosure may also be extended to any frequency band in which transmission is performed by multi-beam.

For unlicensed frequency bands, transmission within Channel Occupancy Time (COT) may be resumed by the transmission resuming mechanism of the COT. Specifically, after the gap, which is between two transmissions within the COT of an initiating device that initiates COT detection, is greater than the maximum gap, Y, the initiating device may resume the transmission within the COT by Category 2 (Cat 2) Listen Before Talk (LBT). In other words, in the transmission resuming mechanism of the COT, the maximum gap is defined based on the existence of the transmission on the initiating device. The initiating device may determine, by the maximum gap defined based on the existence of the transmission on the initiating device, whether to perform the Cat 2 LBT before the transmission within the COT is resumed.

However, the initiating device may communicate with multiple responding devices. Therefore, by the maximum gap defined based on the existence of the transmission on the initiating device alone, there are only two cases, i.e., transmission between the initiating device and all of the responding devices is resumed within the COT, or transmission between the initiating device and all of the responding devices is not resumed within the COT, which reduces the resuming effect of transmission resuming.

In view of the above, embodiments of the disclosure provide a wireless communication method, a first device, and a second device. The method provided by the disclosure may not only reduce the complexity of transmission resuming, but also improve the resuming effect of transmission resuming.

FIG. 2 illustrates a schematic flowchart of a wireless communication method 200 according to an embodiment of the disclosure, and the method 200 may be performed by a first device. The first device may also be referred to as an initiating device that initiates COT detection, for example, the terminal device shown in FIG. 1 or the access network device shown in FIG. 1.

As shown in FIG. 2, the method 200 may includes the following operations.

In operation S210, when a gap between two neighboring transmissions within Channel Occupancy Time (COT) is greater than or equal to a first gap, Category 2 Listen Before Talk (Cat 2 LBT) is performed before a last transmission of the two neighboring transmissions is performed. Here, the first gap includes a first maximum gap and/or a second maximum gap, the first maximum gap is the maximum gap in which none of beams has data transmission within the COT, and the second maximum gap is the maximum gap in which one beam has no data transmission within the COT.

In operation S220, the last transmission is resumed based on a performing result of the Cat 2 LBT.

In the embodiment, the first maximum gap and the second maximum gap are defined from the perspective of beams. Based on this, when a gap between two neighboring transmissions within COT is greater than or equal to the redefined maximum gap, the first device executes Cat 2 LBT before performing a last transmission of the two neighboring transmissions; and resumes the last transmission based on a performing result of the Cat 2 LBT. In other words, the disclosure takes the effect of beams into account, and defines two types of maximum gaps, i.e. the first maximum gap and the second maximum gap, taking beams as a granularity of maximum gaps. On one hand, when the first device may resume the last transmission by the first maximum gap, it is equivalent to that the last transmission may be resumed from the perspective of the first device, which reduces the complexity of transmission resuming. On the other hand, when the first device resumes the last transmission by the second maximum gap, it is equivalent to that the last transmission may be resumed from the perspective of beams, which refines the resuming granularity of transmission resuming and improves the resuming effect of the transmission resuming mechanism.

In short, the method provided by the disclosure may not only reduce the complexity of transmission resuming, but also improve the resuming effect of transmission resuming.

Optionally, the Cat 2 LBT is LBT with a channel listening time of 8 us on high-frequency unlicensed frequency bands. Of course, the Cat 2 LBT may be LBT with a channel listening time of other values on other unlicensed frequency bands, which is not specifically limited by the disclosure. For example, in other alternative embodiments, the Cat 2 LBT may be LBT with a channel listening time of 16 us or 25 us on low-frequency unlicensed frequency bands. Furthermore, it is to be noted that the disclosure does not limit the specific value of the first gap. For example, in a possible implementation, the value of Y includes, but is not limited to: Y=8 us; Y is multiple OFDM symbols; and Y is determined by the network device. For example, Y is determined by the network device based on regulations.

In some embodiments, the first gap includes the first maximum gap, and the operation S210 may include the following operation.

When a second gap is greater than or equal to the first maximum gap, the Cat 2 LBT is performed before the last transmission is performed. Here, the second gap is a gap, in which none of the beams has data transmission, between the two neighboring transmissions.

Exemplarily, if the transmission within the COT is resumed by the first gap, when the second gap is greater than or equal to the first maximum gap, the first device may resume the last transmission by performing the Cat 2 LBT before performing the last transmission.

Optionally, the Cat 2 LBT is performed by a beam covering the all beams.

Exemplarily, if the transmission within the COT is resumed by the first gap, when the second gap is greater than or equal to the first maximum gap, the first device may perform the Cat 2 LBT by a beam covering the all beams before performing the last transmission, and then resume the last transmission based on the performing result of the Cat 2 LBT.

Optionally, the Cat 2 LBT is performed by each of the all beams.

Exemplarily, if the transmission within the COT is resumed by the first gap, when the second gap is greater than or equal to the first maximum gap, the first device may perform the Cat 2 LBT by each of the all beams before performing the last transmission, and then resume the last transmission based on the performing result of the Cat 2 LBT.

Optionally, a beam of the first device for performing the Cat 2 LBT is the same as a beam of the first device for initiating a detection of the COT, and/or, a beam used by the first device for performing the Cat 2 LBT is determined by the first device.

Exemplarily, if the first device uses a beam that may cover the all beams when initiating the COT detection, the first device executes the Cat 2 LBT by the beam that may cover the all beams when resuming the transmission within the COT by the first gap, and then resumes the last transmission based on the performing result of the Cat 2 LBT. If the first device executes the Cat 2 LBT by each of the all beams when initiating the COT detection, the first device executes the Cat 2 LBT by each of the all beams when resuming the transmission within the COT by the first gap, and then resumes the last transmission based on the performing result of the Cat 2 LBT.

Exemplarily, the first device itself may determine the beam used for performing the Cat 2 LBT.

In some embodiments, the first gap includes the second maximum gap, and the operation S210 may include the following operation.

When a third gap is greater than or equal to the second maximum gap, the Cat 2 LBT is performed before the last transmission is performed. Here, the third gap is a gap, in which a same beam corresponding to the two neighboring transmissions has no data trasmission, between the two neighboring transmissions.

Exemplarily, if the transmission within the COT is resumed by the first gap, when the third gap is greater than or equal to the second maximum gap, the first device may resume the last transmission by performing the Cat 2 LBT before performing the last transmission.

Optionally, the Cat 2 LBT is performed by the same beam.

Exemplarily, if the transmission within the COT is resumed by the first gap, when the third gap is greater than or equal to the second maximum gap, the first device may perform the Cat 2 LBT by the same beam before performing the last transmission, and then resume the last transmission based on the performing result of the Cat 2 LBT.

Optionally, the all beams include multiple to-be-resumed beams, and the multiple to-be-resumed beams include the same beam.

Optionally, the Cat 2 LBT is performed by a beam covering the multiple to-be-resumed beams.

Exemplarily, if the transmission within the COT is resumed by the first gap and the all beams include multiple to-be-resumed beams, when the third gap is greater than or equal to the second maximum gap, the first device may perform the Cat 2 LBT by a beam covering the multiple to-be-resumed beams before performing the last transmission, and then resume the last transmission based on the performing result of the Cat 2 LBT.

Optionally, the Cat 2 LBT is performed by each of the multiple to-be-resumed beams.

Exemplarily, if the transmission within the COT is resumed by the first gap and the all beams include multiple to-be-resumed beams, when the third gap is greater than or equal to the second maximum gap, the first device may perform the Cat 2 LBT by each of the multiple to-be-resumed beams before performing the last transmission, and then resume the last transmission based on the performing result of the Cat 2 LBT.

Optionally, a beam of the first device for performing the Cat 2 LBT is the same as a beam of the first device for initiating a detection of the COT, and/or, a beam used by the first device for performing the Cat 2 LBT is determined by the first device.

Exemplarily, if the first device uses a beam that may cover the all beams when initiating the COT detection, the first device executes the Cat 2 LBT by a beam that may cover the multiple to-be-resumed beams when resuming the transmission within the COT by the first gap, and then resumes the last transmission based on the performing result of the Cat 2 LBT. If the first device executes the Cat 2 LBT by each of the all beams when initiating the COT detection, the first device executes the Cat 2 LBT by each of the multiple to-be-resumed beams when resuming the transmission within the COT by the first gap, and then resumes the last transmission based on the performing result of the Cat 2 LBT.

Exemplarily, the first device itself may determine the beam used for performing the Cat 2 LBT.

In some embodiments, the first gap includes the first maximum gap and the second maximum gap, and the two neighboring transmissions correspond to the same beam. The operation S210 may include the following operation.

When a second gap is greater than or equal to the first maximum gap and a third gap is greater than or equal to the second maximum gap, the Cat 2 LBT is performed before the last transmission is performed. Here, the second gap is a gap, in which none of the beams has data transmission, between the two neighboring transmissions. The third gap is a gap, in which a same beam corresponding to the two neighboring transmissions has no data trasmission, between the two neighboring transmissions.

For example, when the second gap is greater than or equal to the first maximum gap and the third gap is greater than or equal to the second maximum gap, before the last transmission is performed, the Cat 2 LBT may be performed in the following manners.

### First Manner

The Cat 2 LBT is performed by a beam covering the all beams.

### Second Manner

The Cat 2 LBT is performed by each of the all beams.

In other words, the first gap includes the first maximum gap and the second maximum gap, and the two neighboring transmissions correspond to the same beam. When the second gap is greater than or equal to the first maximum gap and the third gap is greater than or equal to the second maximum gap, the Cat 2 LBT may be performed directly for all beams within the COT preferentially by the first maximum gap.

Exemplarily, since the first gap includes the first maximum gap and the second maximum gap, when the first device does not transmit in a certain beam direction, it is possible to start calculating the gap between two transmissions in the certain beam direction; subsequently, if it is found that the first device does not transmit in all beam directions, it is further necessary to start calculating the gap in which none of beam directions has transmission. When the gap in which none of beam directions has transmission is greater than or equal to the first maximum gap, the first device is required to perform Cat 2 LBT once by the all beams in order to resume transmission. When the gap in which none beam directions has transmission is less than the first maximum gap, and the gap between two transmissions in a certain beam direction is greater than or equal to the second maximum gap, the first device is required to perform Cat 2 LBT once only in the certain beam direction to resume transmission in the certain beam direction.

In some embodiments, after the first device executes Cat 2 LBT by all beams within the COT, the third gap is between the end moment of the first device performing the Cat 2 LBT by the all beams within the COT and the last transmission of the two neighboring transmissions, and the third gap is a gap in which no data transmission is performed on a same beam corresponding to the two neighboring transmissions.

In other words, after the first device executes Cat 2 LBT by all beams within the COT, the third gap starts from 0.

In some embodiments, the two neighboring transmissions include two neighboring transmissions of the first device.

In some embodiments, the operation S210 may include the following operation.

If the transmission within the COT is resumed by the first gap, when the gap between the two neighboring transmissions is greater than or equal to the first gap, the Cat 2 LBT is performed before the last transmission is performed.

In some embodiments, the method 200 may further include the following operation.

If the transmission within the COT is not resumed by using the first gap, the last transmission is performed within the COT.

In other words, if the transmission within the COT is not resumed by using the first gap, the first device does not need to perform Cat 2 LBT, that is, the last transmission may be performed directly within the COT. Alternatively, if the transmission within the COT is not resumed by using the first gap, the first device performs the last transmission after any gap within the COT and does not need to perform Cat 2 LBT.

It is to be noted that whether the first device resumes the transmission within the COT by the first gap may be determined by the first device or may be indicated by other devices, which is not specifically limited by the disclosure. For example, the first device may determine whether to resume the transmission within the COT by the first gap based on local regulatory requirements. For example, if the regulation requires the usage, the first device resumes the transmission within the COT by the first gap. If the regulation does not require the usage, the last transmission is performed directly within the COT.

The solutions of the disclosure is described below in combination with specific embodiments.

### First Embodiment

In the embodiment, the transmission resuming mechanism of the COT is defined based on the existence of transmission of the first device on all beams within the COT.

Exemplarily, the transmission resuming mechanism may include the following solutions.

### First Solution

If the transmission within the COT is not resumed by using the first gap, the last transmission is performed within the COT. Alternatively, if the transmission within the COT is not resumed by using the first gap, the first device performs the last transmission after any gap within the COT and does not need to perform Cat 2 LBT.

### Second Solution

If the transmission within the COT is resumed by the first gap, when the second gap is greater than or equal to the first maximum gap, the first device may resume the last transmission by performing the Cat 2 LBT before performing the last transmission. Here, the second gap is a gap, in which none of the beams has data transmission, between the two neighboring transmissions.

Specifically, whether the first device resumes the last transmission by first solution or second solution may be determined by the first device, for example, may be determined by the first device based on local regulatory requirements. Specifically, if the regulation does not require the usage, the first device may perform the last transmission directly within the COT based on first solution. If the regulation requires the usage, the first device resumes the transmission within the COT by the first gap based on second solution.

Further, the Cat 2 LBT is performed in the following manners.

### First Manner

The Cat 2 LBT is performed by a beam covering the all beams.

### Second Manner

The Cat 2 LBT is performed by each of the all beams.

Specifically, whether the first device executes the Cat 2 LBT in manner 1 or second manner may be consistent with the manner adopted by the first device for initiating the COT detection, or may be determined by the first device, which is not further limited by the embodiment.

Exemplarily, if the first device uses a beam that may cover the all beams when initiating the COT detection, the first device executes the Cat 2 LBT by the beam that may cover the all beams when resuming the transmission within the COT by the first gap, and then resumes the last transmission based on the performing result of the Cat 2 LBT. If the first device executes the Cat 2 LBT by each of the all beams when initiating the COT detection, the first device executes the Cat 2 LBT by each of the all beams when resuming the transmission within the COT by the first gap, and then resumes the last transmission based on the performing result of the Cat 2 LBT. Exemplarily, the first device itself may determine the beam used for performing the Cat 2 LBT.

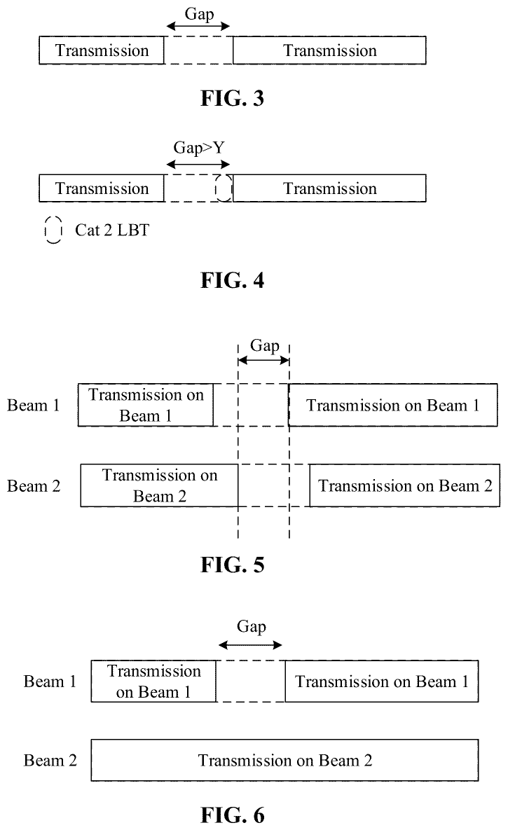

FIG. 3 is a schematic diagram of not resuming transmission within COT by the maximum gap corresponding to all beams within the COT, which is provided by an embodiment of the disclosure.

As shown in FIG. 3, it is assumed that the first device is only allowed to perform data transmission on beam 1 within the COT (i.e., all beams within the COT only include beam 1), and that there is a to-be-resumed transmission on beam 1, i.e., that there are two neighboring transmissions on beam 1, the last of which is a to-be-resumed transmission. If the transmission within the COT is not resumed by using the first gap, the last transmission may be performed directly within the COT. In other words, regardless of the size of the gap between the two neighboring transmissions, the first device may perform the last transmission directly after any gap within the COT and does not need to perform Cat 2 LBT.

FIG. 4 is a schematic diagram of resuming transmission within COT by the maximum gap corresponding to all beams within the COT, which is provided by an embodiment of the disclosure.

As shown in FIG. 4, it is assumed that the first device is only allowed to perform data transmission on beam 1 within the COT (i.e., all beams within the COT only include beam 1), and that there is a to-be-resumed transmission on beam 1, i.e., that there are two neighboring transmissions on beam 1, the last of which is a to-be-resumed transmission. If the transmission within the COT is resumed by the first gap, assuming that the first maximum gap is Y, then when the gap between two neighboring transmissions in the direction of beam 1 is greater than or equal to Y, the first device is required to resume the transmission by performing the Cat 2 LBT before performing the last transmission in the direction of beam 1 within the COT.

FIG. 5 is another schematic diagram of resuming transmission within COT by the maximum gap corresponding to all beams within the COT, which is provided by an embodiment of the disclosure.

As shown in FIG. 5, it is assumed that the first device is allowed to perform data transmission on beam 1 and beam 2 within the COT, and that there is a respective to-be-resumed transmission on beam 1 and beam 2, i.e., that there are two neighboring transmissions on both beam 1 and beam 2, the respective last transmission of which is a to-be-resumed transmission. If the transmission within the COT is resumed by the first gap, assuming that the first maximum gap is Y, then the calculation of the gap starts when no data transmission is performed in both the direction of beam 1 and the direction of beam 2. If the calculated gap is greater than or equal to Y, the first device is required to resume the transmission by performing the Cat 2 LBT before performing the last transmission on beam 1 or the last transmission on beam 2.

### Second Embodiment

In the embodiment, the transmission resuming mechanism of the COT is defined based on the existence of transmission of the first device on a beam within the COT.

Exemplarily, the transmission resuming mechanism may include the following solutions.

### First Solution

If the transmission within the COT is not resumed by using the first gap, the last transmission is performed within the COT. Alternatively, if the transmission within the COT is not resumed by using the first gap, the first device performs the last transmission after any gap within the COT and does not need to perform Cat 2 LBT.

### Second Solution

If the transmission within the COT is resumed by the first gap, when a third gap is greater than or equal to the second maximum gap, the first device executes the Cat 2 LBT before performing the last transmission. Here, the third gap is a gap, in which a same beam corresponding to the two neighboring transmissions has no data trasmission, between the two neighboring transmissions.

Specifically, whether the first device resumes the last transmission by first solution or second solution may be determined by the first device, for example, may be determined by the first device based on local regulatory requirements. Specifically, if the regulation does not require the usage, the first device may perform the last transmission directly within the COT based on first solution. If the regulation requires the usage, the first device resumes the transmission within the COT by the first gap based on second solution.

Further, the Cat 2 LBT is performed in the following manners.

### First Manner

If the all beams include one to-be-resumed beam, the Cat 2 LBT is performed by the one to-be-resumed beam.

### Second Manner

If the all beams include multiple to-be-resumed beams, the Cat 2 LBT is performed by a beam covering the multiple to-be-resumed beams.

### Third Manner

If the all beams include multiple to-be-resumed beams, the Cat 2 LBT is performed by each of the multiple to-be-resumed beams.

Specifically, if the all beams include multiple to-be-resumed beams, whether the first device executes the Cat 2 LBT in second manner or third manner may be consistent with the manner adopted by the first device for initiating the COT detection, or may be determined by the first device, which is not further limited by the embodiment.

Exemplarily, if the first device uses a beam that may cover the all beams when initiating the COT detection, the first device executes the Cat 2 LBT by a beam that may cover the multiple to-be-resumed beams when resuming the transmission within the COT by the first gap, and then resumes the last transmission based on the performing result of the Cat 2 LBT. If the first device executes the Cat 2 LBT by each of the all beams when initiating the COT detection, the first device executes the Cat 2 LBT by each of the multiple to-be-resumed beams when resuming the transmission within the COT by the first gap, and then resumes the last transmission based on the performing result of the Cat 2 LBT. Exemplarily, the first device itself may determine the beam used for performing the Cat 2 LBT.

FIG. 6 is a schematic diagram of not resuming transmission within COT by the maximum gap in which one beam has no data transmission within the COT, which is provided by an embodiment of the disclosure.

As shown in FIG. 6, it is assumed that the first device is allowed to perform data transmission on beam 1 and beam 2 within the COT, and that there is a to-be-resumed transmission on beam 1, i.e., that there are two neighboring transmissions on beam 1, the last of which is a to-be-resumed transmission. If the transmission within the COT is not resumed by using the first gap, the last transmission may be performed directly in the direction of beam 1 within the COT. In other words, regardless of the size of the gap between the two neighboring transmissions, the first device may perform the last transmission directly after any gap within the COT and does not need to perform Cat 2 LBT.

FIG. 7 is a schematic diagram of resuming transmission within COT by the maximum gap in which one beam has no data transmission within the COT, which is provided by an embodiment of the disclosure.

As shown in FIG. 7, it is assumed that the first device is allowed to perform data transmission on beam 1 and beam 2 within the COT, and that there is a to-be-resumed transmission on beam 1, i.e., that there are two neighboring transmissions on beam 1, the last of which is a to-be-resumed transmission. If the transmission within the COT is resumed by the first gap, assuming that the second maximum gap is Y, then when the gap between two neighboring transmissions in the direction of beam 1 is greater than or equal to Y, the first device is required to resume the transmission by performing the Cat 2 LBT, before performing the last transmission in the direction of beam 1 within the COT.

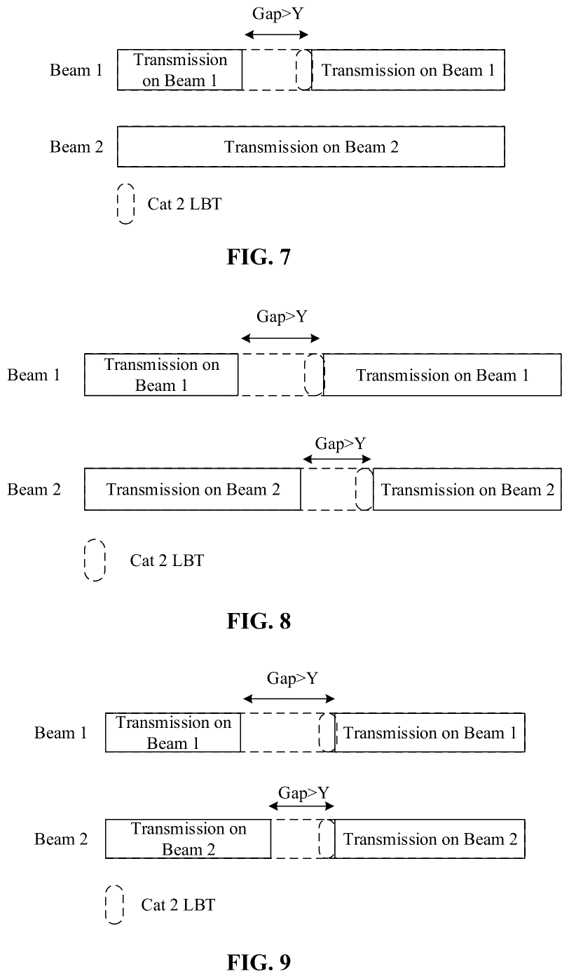

FIG. 8 is a schematic diagram of preforming Cat 2 LBT by each to-be-resumed beam when transmission within COT is resumed by the maximum gap in which one beam has no data transmission within the COT, which is provided by an embodiment of the disclosure.

As shown in FIG. 8, it is assumed that the first device is allowed to perform data transmission on beam 1 and beam 2 within the COT, and that there is a respective to-be-resumed transmission on beam 1 and beam 2, i.e., that there are two neighboring transmissions on both beam 1 and beam 2, the respective last transmission of which is a to-be-resumed transmission. If the transmission within the COT is resumed by the first gap, assuming that the second maximum gap is Y, when the start position of the last transmission on beam 1 is different from the start position of the last transmission on beam 2, transmission resuming may be performed for a single beam. For example, when the gap between two neighboring transmissions in the direction of beam 1 is greater than or equal to Y, the first device is required to resume the transmission in the direction of beam 1 within the COT by performing the Cat 2 LBT, before performing the last transmission in the direction of beam 1 within the COT. Further, for example, when the gap between two neighboring transmissions in the direction of beam 2 is greater than or equal to Y, the first device is required to resume the transmission in the direction of beam 2 within the COT by performing the Cat 2 LBT, before performing the last transmission in the direction of beam 2 within the COT.

FIG. 9 is a schematic diagram of preforming Cat 2 LBT by a beam covering multiple to-be-resumed beams when transmission within COT is resumed by the maximum gap in which one beam has no data transmission within the COT, which is provided by an embodiment of the disclosure.

As shown in FIG. 9, it is assumed that the first device is allowed to perform data transmission on beam 1 and beam 2 within the COT, and that there is a respective to-be-resumed transmission on beam 1 and beam 2, i.e., that there are two neighboring transmissions on both beam 1 and beam 2, the respective last transmission of which is a to-be-resumed transmission. If the transmission within the COT is resumed by the first gap, assuming that the second maximum gap is Y, when the start position of the last transmission on beam 1 is the same as the start position of the last transmission on beam 2, transmission resuming may be performed by a beam that may cover both beam 1 and beam 2. For example, when the gap between two neighboring transmissions in the direction of beam 1 is greater than or equal to Y and the gap between two neighboring transmissions in the direction of beam 2 is greater than or equal to Y, the first device may resume the transmission in the direction of beam 1 and the transmission in the direction of beam 2 within the COT simultaneously by performing the Cat 2 LBT by the beam that may cover both beam 1 and beam 2, before performing the last transmission in the direction of beam 1 and the last transmission in the direction of beam 2 within the COT.

Of course, in other alternative embodiments, even if the start position of the last transmission on beam 1 is the same as the start position of the last transmission on beam 2, the Cat 2 LBT may also be performed by beam 1 and beam 2 respectively, which is not specifically limited by the disclosure.

### Third Embodiment

In the embodiment, the transmission resuming mechanism of the COT may be defined simultaneously based on the existence of transmission of the first device on all beams within the COT, and the existence of transmission of the first device on a beam within the COT.

Exemplarily, the transmission resuming mechanism may include the following solutions.

### First Solution

If the transmission within the COT is not resumed by using the first gap, the last transmission is performed within the COT. Alternatively, if the transmission within the COT is not resumed by using the first gap, the first device performs the last transmission after any gap within the COT and does not need to perform Cat 2 LBT.

### Second Solution

If the transmission within the COT is resumed by the first gap, when a gap between two neighboring transmissions within the Channel Occupancy Time (COT) is greater than or equal to a first gap, the first device executes Category 2 Listen Before Talk (Cat 2 LBT) before performing a last transmission of the two neighboring transmissions. Here, the first gap includes a first maximum gap and a second maximum gap.

Specifically, the transmission resuming mechanism may include the following cases.

### First Case

When a second gap is greater than or equal to the first maximum gap, the first device executes the Cat 2 LBT before preforming the last transmission. Here, the second gap is a gap, in which none of the beams has data transmission, between the two neighboring transmissions.

### Second Case

When a third gap is greater than or equal to the second maximum gap, the first device executes the Cat 2 LBT before preforming the last transmission. Here, the third gap is a gap, in which a same beam corresponding to the two neighboring transmissions has no data trasmission, between the two neighboring transmissions.

### Third Case

When a second gap is greater than or equal to the first maximum gap and a third gap is greater than or equal to the second maximum gap, the Cat 2 LBT is performed before the last transmission is performed. Here, the second gap is a gap, in which none of the beams has data transmission, between the two neighboring transmissions. The third gap is a gap, in which a same beam corresponding to the two neighboring transmissions has no data trasmission, between the two neighboring transmissions.

For example, when the second gap is greater than or equal to the first maximum gap and the third gap is greater than or equal to the second maximum gap, before the last transmission is performed, the Cat 2 LBT may be performed in the following manners.

### First Manner

The Cat 2 LBT is performed by a beam covering the all beams.

### Second Manner

The Cat 2 LBT is performed by each of the all beams.

In other words, the first gap includes the first maximum gap and the second maximum gap, and the two neighboring transmissions correspond to the same beam. When the second gap is greater than or equal to the first maximum gap and the third gap is greater than or equal to the second maximum gap, the Cat 2 LBT may be performed directly for all beams within the COT preferentially by the first maximum gap.

Furthermore, after the first device executes Cat 2 LBT by all beams within the COT, the third gap is between the end moment of the first device performing the Cat 2 LBT by the all beams within the COT and the last transmission of the two neighboring transmissions, and the third gap is a gap in which no data transmission is performed on a same beam corresponding to the two neighboring transmissions.

In other words, after the first device executes Cat 2 LBT by all beams within the COT, the third gap starts from 0.

It is to be understood that the specific solutions of case 1 and case 2 may refer to the solutions of embodiment 1 and embodiment 2 respectively, which will not be repeated here to avoid repetition.

Specifically, whether the first device resumes the last transmission by first solution or second solution may be determined by the first device, for example, may be determined by the first device based on local regulatory requirements. Specifically, if the regulation does not require the usage, the first device may perform the last transmission directly within the COT based on first solution. If the regulation requires the usage, the first device resumes the transmission within the COT by the first gap based on second solution.

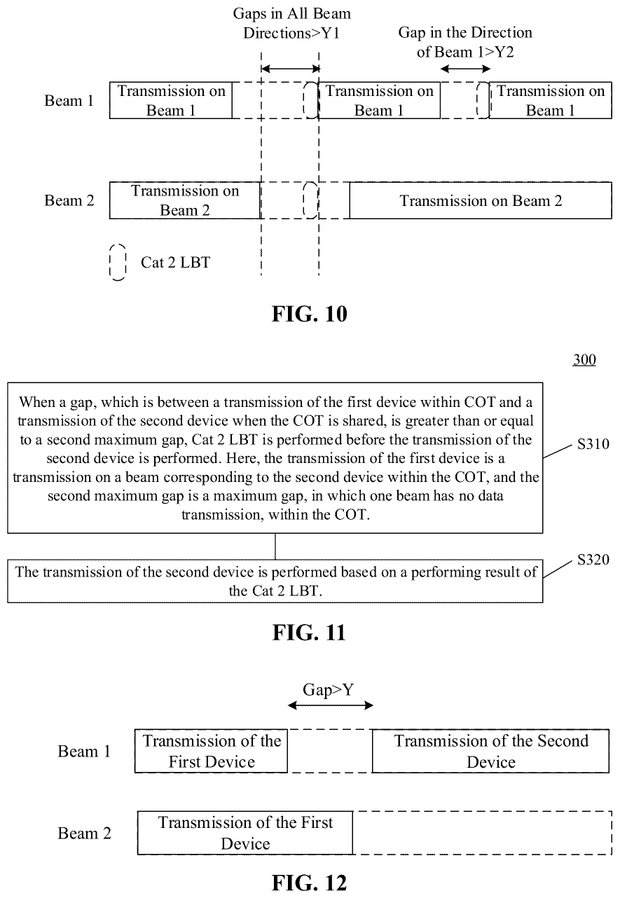

FIG. 10 is a schematic diagram of resuming transmission within COT by the maximum gap corresponding to all beams within the COT and the maximum gap in which one beam has no data transmission within the COT simultaneously, which is provided by an embodiment of the disclosure.

As shown in FIG. 10, it is assumed that the first device is allowed to perform data transmission on beam 1 and beam 2 within the COT, and that there is a respective to-be-resumed transmission on beam 1 and beam 2. Specifically, there are three consecutive transmissions on beam 1, and there are two neighboring transmissions on beam 2. If the transmission within the COT is resumed by the first gap, it is assumed that the first maximum gap is Y1 and the second maximum gap is Y2. As an example, the first device may start calculating the gap (the intersection of the gap between the first and second transmission on beam 1 and the gap between the first and second transmission on beam 2) when no data transmission is performed in both the direction of beam 1 and the direction of beam 2. When the calculated gap is greater than or equal to Y1, it is necessary to resume the transmission by performing the Cat 2 LBT. As another example, when the gap between the second and third transmission of the first device in the direction of beam 1 is greater than or equal to Y2, the first device is required to resume the transmission by performing the Cat 2 LBT, before performing the third transmission in the direction of beam 1 within the COT. As another example, when the gap between the start position of the second transmission of the first device in the direction of beam 1 and the second transmission in the direction of beam 2 is greater than or equal to Y2, the first device is required to resume the transmission by performing the Cat 2 LBT, before performing the second transmission in the direction of beam 2 within the COT.

In other words, the first device may perform data transmission on beam 1 and beam 2.

Specifically, after the first device transmits the first transmission on beam 1, there starts to be no data transmission on beam 1, and the first device may start calculating the gap on beam 1. Subsequently, after the first device transmits the first transmission on beam 2, there is no transmission on both beam 1 and beam 2, and the first device starts calculating the collective gap on both beam 1 and beam 2. If the collective gap on both beams 1 and beam 2 is greater than or equal to Y1, the first device is required to perform Cat 2 LBT once to resume transmission. Furthermore, when there is still no data transmission on beam 2 after the first device executes the Cat 2 LBT, the first device is required to restart calculating the gap on beam 2. If the calculated gap on beam 2 is greater than or equals to Y2 before the second transmission on beam 2, it is not necessary to perform the Cat 2 LBT, that is, the first device may directly transmit the second transmission on beam 2.

Furthermore, after the first device transmits the second transmission on beam 1, there starts to be no data transmission on beam 1, and the calculation of the gap on beam 1 is restarted. If the calculated gap on beam 1 (i.e., the gap between the second and third transmission on beam 1) is greater than Y2 before the third transmission on beam 1, the first device is required to perform Cat 2 LBT once on beam 1 to resume transmission in the direction of beam 1.

The wireless communication method according to the embodiments of the disclosure is described in detail above in combination with FIGS. 2 to 10 from the perspective of the first device. The wireless communication method according to the embodiments of the disclosure will be described below in combination with FIGS. 11 and 12 from the perspective of the second device.

FIG. 11 illustrates a schematic flowchart of a wireless communication method 300 according to an embodiment of the disclosure. The method 300 may be performed by a second device, for example, the terminal device shown in FIG. 1 or the access network device shown in FIG. 1.

As shown in FIG. 11, the method 300 may include the following operations.

In operation S310, when a gap, which is between a transmission of the first device within Channel Occupancy Time (COT) and a transmission of the second device when the COT is shared, is greater than or equal to a second maximum gap, Category 2 Listen Before Talk (Cat 2 LBT) is performed before the transmission of the second device is performed. Here, the transmission of the first device is a transmission on a beam corresponding to the second device within the COT, and the second maximum gap is a maximum gap, in which one beam has no data transmission, within the COT.

In operation S320, the transmission of the second device is performed based on a performing result of the Cat 2 LBT.

In the embodiment, the second maximum gap is defined from the perspective of beams. Based on this, when the gap, which is between the transmission of the first device within COT and the transmission of the second device when the COT is shared, is greater than or equal to the second maximum gap, the second device executes Category 2 Listen Before Talk (Cat 2 LBT) before performing the transmission of the second device. In other words, the disclosure takes the effect of beams into account, and defines the second maximum gap taking beams as a granularity of maximum gaps. When the second device performs the transmission of the second device by the second maximum gap, it is equivalent to that the COT initiated by the first device may be shared from the perspective of beams, which refines the sharing granularity of the COT and improves the sharing effect.

It is to be noted that in some embodiments, the transmission of the first device is before the transmission of the second device, and the operation S310 may include the following operation.

When a gap between the end position of the transmission of the first device and the start position of the transmission of the second device is greater than or equal to the second maximum gap, the Cat 2 LBT is performed before the transmission of the second device is performed.

In some embodiments, the operation S310 may include the following operation.

If the second maximum gap is used, when a gap between the transmission of the first device and the transmission of the second device is greater than or equal to the second maximum gap, the Cat 2 LBT is performed before the transmission of the second device is performed.

In some embodiments, the method 300 may further include the following operation.

If the second maximum gap is not used, the transmission of the second device is performed within the shared COT.

It is to be noted that whether the second device transmits the transmission of the second device by the second maximum gap in a manner of sharing the COT may be determined by the second device or may be indicated by other devices, which is not specifically limited by the disclosure. For example, the second device may determine whether to transmit the transmission of the second device by the second maximum gap in a manner of sharing the COT based on local regulatory requirements. For example, if the regulation requires the usage, the second device transmits the transmission of the second device by the second maximum gap in a manner of sharing the COT. If the regulation does not require the usage, the transmission of the second device is transmitted directly in a manner of sharing the COT.

It is to be understood that the operations in the method 300 may refer to the corresponding operations in the method 200, which are not repeated here for brevity.

The solutions of the disclosure is described below in combination with embodiments.

### Fourth Embodiment

In the embodiment, the transmission sharing mechanism of the second device when the COT is shared is defined based on the existence of transmission on a beam within the COT.

Exemplarily, the transmission sharing mechanism may include the following solutions.

### First Solution

If the transmission of the second device is not transmitted by the second maximum gap in a manner of sharing the COT, the transmission of the second device is transmitted directly in a manner of sharing the COT. In other words, if the transmission of the second device is not transmitted by the second maximum gap in a manner of sharing the COT, the second device performs the transmission of the second device after any gap within the COT and does not need to perform Cat 2 LBT.

### Second Solution

If the transmission of the second device is transmitted by the second maximum gap in a manner of sharing the COT, when a gap, which is between a transmission of the first device within the COT and a transmission of the second device when the COT is shared, is greater than or equal to the second maximum gap, Category 2 Listen Before Talk (Cat 2 LBT) is performed before the transmission of the second device is performed. Here, the transmission of the first device is a transmission on a beam corresponding to the second device within the COT.

Specifically, whether the second device transmits the transmission of the second device in a manner of sharing the COT by first solution or second solution may be determined by the second device, for example, may be determined by the second device based on local regulatory requirements. Specifically, if the regulation does not require the usage, the second device may transmit the transmission of the second device directly in a manner of sharing the COT based on first solution. If the regulation requires the usage, the second device transmits the transmission of the second device by the first gap in a manner of sharing the COT based on second solution.

Further, the Cat 2 LBT is performed in the following manner.

### First Manner

The second device executes the Cat 2 LBT by a beam corresponding to the first device within the COT before performing the transmission of the second device.

FIG. 12 is a schematic diagram of resuming transmission of a second device when COT is shared by the maximum gap in which one beam has no data transmission within the COT, which is provided by an embodiment of the disclosure.

As shown in FIG. 12, it is assumed that within the COT, the first device performs data transmission on beam 1 and beam 2, and that beam 1 is the beam corresponding to the second device. Even if the end position of the transmission of the first device on beam 2 is later, beam 1 is the beam corresponding to the second device. If the gap, which is between the start position of the transmission of the second device and the end position of the transmission of the first device on beam 1, is greater than the maximum gap in which one beam has no data transmission within the COT, the second device is required to perform Cat 2 LBT before performing the transmission of the second device.

The preferred implementations of the disclosure are described in detail above in combination with the drawings, but the disclosure is not limited to the specific details in the above implementations. Within the scope of the technical conception of the disclosure, a variety of simple variations of the technical solutions of the disclosure may be carried out, and all of these simple variations fall within the scope of protection of the disclosure. For example, the various specific technical features described in the above specific implementations may be combined in any suitable manner without contradiction, and in order to avoid unnecessary repetition, various possible combinations are not separately illustrated in the disclosure. Further, for example, various different implementations of the disclosure may also be combined in any manner, and as long as they do not contradict the idea of the disclosure, they should be regarded as the contents disclosed in the disclosure.

It is further to be understood that in the various method embodiments of the disclosure, the magnitude of the serial numbers of the above processes does not imply the order of performing, and the order of performing of the processes shall be determined by their functions and internal logic, and shall not constitute any limitation to the implementation process of the embodiments of the disclosure. Furthermore, in the embodiments of the disclosure, the terms “downlink” and “uplink” are used to represent a transmission direction of signals or data, here, “downlink” is used to represent that the transmission direction of signals or data is a first direction from the site to the user device of the cell, and “uplink” is used to represent that the transmission direction of signals or data is a second direction from the user device of the cell to the site, for example, a “downlink signal” represents that the signal is transmitted in the first direction. Furthermore, in the embodiments of the disclosure, the term “and/or” is only a description of an association relationship of associated objects, representing that there may be three kinds of relationships. For example, A and/or B may represent three conditions: i.e., independent existence of A, existence of both A and B and independent existence of B. Furthermore, the character “/” herein usually represents that the previous and next associated objects are in an “or” relationship.

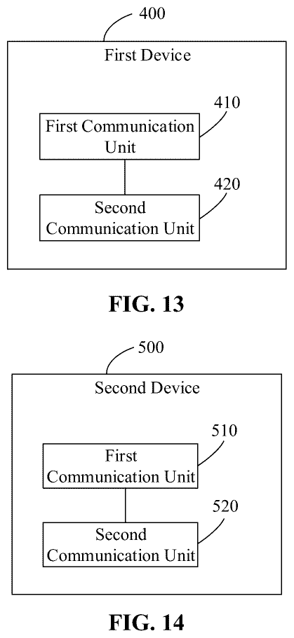

The method embodiments of the disclosure are described in detail above in combination with FIGS. 1 to 12, and the apparatus embodiments of the disclosure are described in detail below in combination with FIGS. 13 to 16.

FIG. 13 is a schematic block diagram of a first device 400 of an embodiment of the disclosure.

As shown in FIG. 13, the first device 400 may include a first communication unit 410 and a second communication unit 420.

The first communication unit 410 is configured to: when a gap between two neighboring transmissions within Channel Occupancy Time (COT) is greater than or equal to a first gap, perform Category 2 Listen Before Talk (Cat 2 LBT) before a last transmission of the two neighboring transmissions is performed. Here, the first gap includes a first maximum gap and/or a second maximum gap, the first maximum gap is a maximum gap, in which none of beams has data transmission, within the COT, and the second maximum gap is a maximum gap, in which one beam has no data transmission, within the COT.

The second communication unit 420 is configured to resume the last transmission based on a performing result of the Cat 2 LBT.

In some embodiments, the first gap includes the first maximum gap.

Here, the first communication unit 410 is specifically configured to:
when a second gap is greater than or equal to the first maximum gap, perform the Cat 2 LBT before the last transmission is performed. Here, the second gap is a gap, in which none of the beams has data transmission, between the two neighboring transmissions.

In some embodiments, the first communication unit 410 is specifically configured to:
perform the Cat 2 LBT by a beam covering the all beams; or
perform the Cat 2 LBT by each of the all beams.

In some embodiments, the first gap includes the second maximum gap.

Here, the first communication unit 410 is specifically configured to:
when a third gap is greater than or equal to the second maximum gap, perform the Cat 2 LBT before the last transmission is performed. Here, the third gap is a gap, in which a same beam corresponding to the two neighboring transmissions has no data trasmission, between the two neighboring transmissions.

In some embodiments, the first communication unit 410 is specifically configured to:
perform the Cat 2 LBT by the same beam.

In some embodiments, the all beams include multiple to-be-resumed beams, and the multiple to-be-resumed beams include the same beam.

Here, the first communication unit 410 is specifically configured to:
perform the Cat 2 LBT by a beam covering the multiple to-be-resumed beams; or
perform the Cat 2 LBT by each of the multiple to-be-resumed beams.

In some embodiments, a beam of the first device for performing the Cat 2 LBT is the same as a beam of the first device for initiating a detection of the COT, and/or, a beam used by the first device for performing the Cat 2 LBT is determined by the first device.

In some embodiments, the two neighboring transmissions include two neighboring transmissions of the first device.

In some embodiments, the first communication unit 410 is specifically configured to:
if transmission within the COT is resumed by using the first gap, when the gap between the two neighboring transmissions is greater than or equal to the first gap, perform the Cat 2 LBT before the last transmission is performed.

In some embodiments, the second communication unit 420 is specifically configured to:
if the transmission within the COT is not resumed by using the first gap, perform the last transmission within the COT.

It is to be understood that the apparatus embodiments and the method embodiments may correspond to each other, and a similar description may refer to the method embodiments. Specifically, the first device 400 shown in FIG. 13 may correspond to the corresponding subject that executes the method 200 in the embodiments of the disclosure, and the aforementioned and other operations and/or functions of the various units in the first device 400 are respectively for the purpose of realizing the corresponding flows in the various methods in FIG. 2, which is not repeated here for the sake of brevity.

FIG. 14 is a schematic block diagram of a second device 500 of an embodiment of the disclosure.

As shown in FIG. 14, the second device 500 may include a first communication unit 510 and a second communication unit 520.

The first communication unit 510 is configured to: when a gap, which is between a transmission of a first device within Channel Occupancy Time (COT) and a transmission of the second device when the COT is shared, is greater than or equal to a second maximum gap, perform Category 2 Listen Before Talk (Cat 2 LBT) before the transmission of the second device is performed. Here, the transmission of the first device is a transmission on a beam corresponding to the second device within the COT, and the second maximum gap is a maximum gap, in which one beam has no data transmission, within the COT.

The second communication unit 520 is configured to perform the transmission of the second device based on a performing result of the Cat 2 LBT.

In some embodiments, the transmission of the first device is before the transmission of the second device.

Here, the first communication unit 510 is specifically configured to:
when a gap between an end position of the transmission of the first device and a start position of the transmission of the second device is greater than or equal to the second maximum gap, perform the Cat 2 LBT before the transmission of the second device is performed.

In some embodiments, the first communication unit 510 is specifically configured to:
if the second maximum gap is used, when a gap between the transmission of the first device and the transmission of the second device is greater than or equal to the second maximum gap, perform the Cat 2 LBT before the transmission of the second device is performed.

In some embodiments, the second communication unit 520 is further configured to:
if the second maximum gap is not used, perform the transmission of the second device within the shared COT.

It is to be understood that the apparatus embodiments and the method embodiments may correspond to each other, and a similar description may refer to the method embodiments. Specifically, the second device 500 shown in FIG. 14 may correspond to the corresponding subject that executes the method 300 in the embodiments of the disclosure, and the aforementioned and other operations and/or functions of the various units in the second device 500 are respectively for the purpose of realizing the corresponding flows in the various methods in FIG. 11, which is not repeated here for the sake of brevity.

The communication device of the embodiments of the disclosure is described above from the perspective of functional modules in combination with the drawings. It is to be understood that the functional modules may be implemented in a hardware form, by instructions in a software form, and by a combination of hardware and software modules. Specifically, each operation of the method embodiments in the embodiments of the disclosure may be completed by a hardware integrated logic circuit and/or instructions in a software form in a processor. The operations of the methods disclosed in combination with the embodiments of the disclosure may directly be embodied to be performed and completed by a hardware decoding processor, or performed and completed by a combination of hardware and software modules in a decoding processor. Optionally, the software module may be located in a mature storage medium in the art, such as a Random Access Memory, a flash memory, a Read-Only Memory, a Programmable Read-Only Memory, an Electrically Erasable Programmable Memory or a register. The storage medium is located in a memory, and the processor reads the information in the memory to complete the operations in the above method embodiments in combination with its hardware.

For example, each of the first communication unit 410, the second communication unit 420, the first communication unit 510, and the second communication unit 520 described above may be realized by a transceiver.

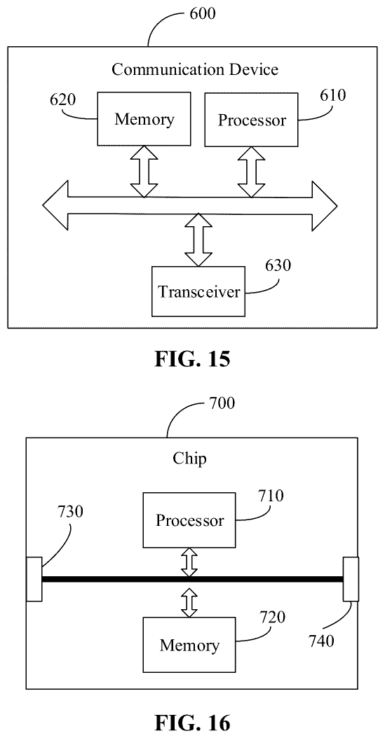

FIG. 15 is a schematic structural diagram of a communication device 600 of an embodiment of the disclosure.

As shown in FIG. 15, the communication device 600 may include a processor 610.

The processor 610 may call and run a computer program in a memory to implement the methods in the embodiments of the disclosure.

As shown in FIG. 15, the communication device 600 may further include a memory 620.

The memory 620 may be configured to store indicative information, and may further be configured to store codes, instructions, or the like, which are performed by the processor 610. The processor 610 may call and run a computer program in the memory 620 to implement the methods in the embodiments of the disclosure. The memory 620 may be a separate component independent of the processor 610, or may be integrated into the processor 610.

As shown in FIG. 15, the communication device 600 may further include a transceiver 630.

The processor 610 may control the transceiver 630 to communicate with other devices, specifically, to send information or data to other devices, or to receive information or data sent by other devices. The transceiver 630 may include a transmitter and a receiver. The transceiver 630 may further include an antenna. The number of the antennas may be one or more.

It is to be understood that various components in the communication device 600 are connected through a bus system. Here, in addition to a data bus, the bus system further includes a power bus, a control bus, and a status signal bus.

It is further to be understood that the communication device 600 may be the first device of the embodiments of the disclosure, and the communication device 600 may implement the corresponding flows implemented by the first device in each method of the embodiments of the disclosure. In other words, the communication device 600 of the embodiments of the disclosure may correspond to the first device 400 in the embodiments of the disclosure, and may correspond to the corresponding main body performing the method 200 of the embodiments of the disclosure, which is not repeated here for the sake of brevity. Similarly, the communication device 600 may be the second device of the embodiments of the disclosure, and the communication device 600 may implement the corresponding flows implemented by the second device in each method of the embodiments of the disclosure. In other words, the communication device 600 of the embodiments of the disclosure may correspond to the second device 500 in the embodiments of the disclosure, and may also correspond to the main body performing the method 300 of the embodiments of the disclosure, which is not repeated here for the sake of brevity.

Furthermore, an embodiment of the disclosure further provides a chip.

For example, the chip may be an integrated circuit chip with signal processing capability for implementing or performing each method, operation, and logic block diagram disclosed in the embodiments of the disclosure. The chip may also be referred to as a system-level chip, a system chip, a chip system, a system-on-chip, or the like. Optionally, the chip may be applied to various communication devices, such that the communication device installed with the chip may perform each method, operation and logic block diagram disclosed in the embodiments of the disclosure.

FIG. 16 is a schematic structural diagram of a chip 700 according to an embodiment of the disclosure.

As shown in FIG. 16, the chip 700 includes a processor 710.

The processor 710 may call and run a computer program in a memory to implement the methods in the embodiments of the disclosure.

As shown in FIG. 16, the chip 700 may further include a memory 720.

The processor 710 may call and run a computer program in the memory 720 to implement the methods in the embodiments of the disclosure. The memory 720 may be configured to store indicative information, and may further be configured to store codes, instructions, or the like, which are performed by the processor 710. The memory 720 may be a separate component independent of the processor 710, or may be integrated into the processor 710.

As shown in FIG. 16, the chip 700 may further include an input interface 730.

The processor 710 may control the input interface 730 to communicate with other devices or chips, specifically, to acquire information or data sent by other devices or chips.

As shown in FIG. 16, the chip 700 may further include an output interface 740.

The processor 710 may control the output interface 740 to communicate with other devices or chips, specifically, to output information or data to other devices or chips.

It is to be understood that the chip 700 may be applied to the first device in the embodiments of the disclosure, and the chip may implement corresponding flows implemented by the first device in each method of the embodiments of the disclosure, and may also implement corresponding flows implemented by the second device in each method of the embodiments of the disclosure, which is not repeated here for the sake of brevity.

It is to be understood that various components in the chip 700 are connected through a bus system. Here, in addition to a data bus, the bus system further includes a power bus, a control bus, and a status signal bus.

The processor referred to above may include, but is not limited to:
a general purpose processor, a Digital Signal Processor (DSP), an Application Specific Integrated Circuit (ASIC), a Field Programmable Gate Array (FPGA) or other programmable logic devices, a discrete gate or a transistor logic device, a discrete hardware component, or the like.

The processor may be configured to implement or perform each method, operation and logic block diagram disclosed in the embodiments of the disclosure. The operations of the method disclosed in combination with the embodiments of the disclosure may be directly embodied to be performed and completed by a hardware decoding processor or performed and completed by a combination of hardware and software modules in a decoding processor. The software module may be located in a mature storage medium in the art, such as a Random Access Memory, a flash memory, a Read-Only Memory, a Programmable Read-Only Memory, an Erasable Programmable Memory or a register. The storage medium is located in a memory, and the processor reads the information in the memory to complete the operations of the above method in combination with its hardware.

The memory referred to above includes, but is not limited to:
a volatile memory and/or a nonvolatile memory. Here, the nonvolatile memory may be a Read-Only Memory (ROM), a Programmable ROM (PROM), an Erasable PROM (EPROM), an Electrically EPROM (EEPROM) or a flash memory. The volatile memory may be a Random Access Memory (RAM), and is used as external high-speed cache. It is exemplarily but unlimitedly illustrated that RAMs in various forms may be adopted, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a synch link DRAM (SLDRAM) and a Direct Rambus RAM (DR RAM).

It is to be noted that the memory described herein is intended to include memories of these and any other proper types.

An embodiment of the disclosure further provides a computer-readable storage medium, which is configured to store a computer program. The computer-readable storage medium stores one or more programs including instructions. When performed by a portable electronic device including multiple application programs, the instructions enable the portable electronic device to perform the wireless communication method provided by the disclosure. Optionally, the computer-readable storage medium may be applied to the first device in the embodiments of the disclosure, and the computer program enables a computer to perform corresponding flows implemented by the first device in each method of the embodiments of the disclosure, which is not repeated here for the sake of brevity. Optionally, the computer-readable storage medium may be applied to the second device in the embodiments of the disclosure, and the computer program enables a computer to perform corresponding flows implemented by the second device in each method of the embodiments of the disclosure, which is not repeated here for the sake of brevity.

An embodiment of the disclosure further provides a computer program product, which includes a computer program. Optionally, the computer program product may be applied to the first device in the embodiments of the disclosure, and the computer program enables a computer to perform corresponding flows implemented by the first device in each method of the embodiments of the disclosure, which is not repeated here for the sake of brevity. Optionally, the computer program product may be applied to the second device in the embodiments of the disclosure, and the computer program enables a computer to perform corresponding flows implemented by the second device in each method of the embodiments of the disclosure, which is not repeated here for the sake of brevity.

An embodiment of the disclosure further provides a computer program. When performed by a computer, the computer program enables the computer to perform the wireless communication method provided by the disclosure. Optionally, the computer program may be applied to the first device in the embodiments of the disclosure, and when the computer program runs in a computer, the computer program enables the computer to perform corresponding flows implemented by the first device in each method of the embodiments of the disclosure, which is not repeated here for the sake of brevity. Optionally, the computer program may be applied to the second device in the embodiments of the disclosure, and when the computer program runs in a computer, the computer program enables the computer to perform corresponding flows implemented by the second device in each method of the embodiments of the disclosure, which is not repeated here for the sake of brevity.

An embodiment of the disclosure further provides a communication system, which may include the above first device and second device, for example, the communication system 100 shown in FIG. 1, which is not repeated here for the sake of brevity. It is to be noted that the term “system” and the like herein may also be referred to as “network management architecture” or “network system”, or the like.

It is further to be understood that the terms used in the embodiments and the appended claims of the disclosure are only for the purpose of describing the specific embodiments and are not intended to limit the embodiments of the disclosure. For example, singular forms “a/an”, “said”, “above” and “the” used in the embodiments and the appended claims of the disclosure are also intended to include plural forms unless other meanings are clearly expressed in the context.

Those skilled in the art may realize that the units and algorithm steps of each example described in combination with the embodiments disclosed in the disclosure may be implemented by electronic hardware or a combination of computer software and electronic hardware. Whether these functions are performed in a hardware or software manner depends on specific applications and design constraints of the technical solutions. Professionals may realize the described functions for each specific application by using different methods, but such realization shall fall within the scope of the embodiments of the disclosure. When realized in form of software functional units and sold or used as an independent product, the function may be stored in a computer-readable storage medium. Based on such an understanding, the technical solutions of the embodiments of the disclosure substantially or parts making contributions to the related art or part of the technical solutions may be embodied in form of a software product, and the computer software product is stored in a storage medium, including multiple instructions configured to enable a computer device (which may be a personal computer, a server, a network device or the like) to perform all or part of the operations of the methods in the embodiments of the disclosure. The aforementioned storage medium includes various media capable of storing program codes such as a USB disk, a mobile hard disk, a ROM, a RAM, a magnetic disk, an compact disk, or the like.

Those skilled in the art may further realize that for convenient and brief description, specific working processes of the systems, apparatuses and units described above may refer to the corresponding processes in the aforementioned method embodiments and will not be repeated here. In some embodiments provided by the disclosure, it is to be understood that the disclosed systems, apparatuses and methods may be implemented in other manners. For example, the division of the units, modules or components in the apparatus embodiments described above is only a kind of logic function division, and other division manners may be adopted during practical implementation. For example, multiple units, modules or components may be combined or integrated into another system, or some units, modules or components may be neglected or not performed. Further, for example, the units/modules/components described above as separate/display parts may or may not be physically separated, i.e., may be located in the same place, or may also be distributed to multiple network units. Part or all of the units/modules/components may be selected according to practical requirements to achieve the purposes of the embodiments of the disclosure. Finally, it is to be noted that, coupling or direct coupling or communication connection between each displayed or discussed component may be indirect coupling or communication connection through some interfaces, apparatuses or units, and may be electrical, mechanical, or in other forms.

The above is only the specific implementations of the embodiments of the disclosure, but the scope of protection of the embodiments of the disclosure is not limited thereto. Any variations or replacements apparent to those skilled in the art within the technical scope disclosed by the embodiments of the disclosure shall fall within the scope of protection of the embodiments of the disclosure. Therefore, the scope of protection of the embodiments of the disclosure shall be subject to the scope of protection of the claims.

1. A wireless communication method, applied to a first device, wherein the method comprises:
when a gap between two neighboring transmissions within Channel Occupancy Time (COT) is greater than or equal to a first gap, performing Category 2 Listen Before Talk (Cat 2 LBT) before a last transmission of the two neighboring transmissions is performed; wherein the first gap comprises a first maximum gap and/or a second maximum gap, the first maximum gap is a maximum gap, in which none of beams has data transmission, within the COT, and the second maximum gap is a maximum gap, in which one beam has no data transmission, within the COT; and
resuming the last transmission based on a performing result of the Cat 2 LBT.

2. The method of claim 1, wherein the first gap comprises the first maximum gap;
wherein the when a gap between two neighboring transmissions within COT is greater than or equal to a first gap, performing Cat 2 LBT before a last transmission of the two neighboring transmissions is performed comprises:
when a second gap is greater than or equal to the first maximum gap, performing the Cat 2 LBT before the last transmission is performed; wherein the second gap is a gap, in which none of the beams has data transmission, between the two neighboring transmissions.

3. The method of claim 2, wherein the performing the Cat 2 LBT comprises:
performing the Cat 2 LBT by a beam covering the all beams; or
performing the Cat 2 LBT by each of the all beams.

4. The method of claim 1, wherein the first gap comprises the second maximum gap;
wherein the when a gap between two neighboring transmissions within COT is greater than or equal to a first gap, performing Cat 2 LBT before a last transmission of the two neighboring transmissions is performed comprises:
when a third gap is greater than or equal to the second maximum gap, performing the Cat 2 LBT before the last transmission is performed; wherein the third gap is a gap, in which a same beam corresponding to the two neighboring transmissions has no data trasmission, between the two neighboring transmissions.

5. The method of claim 4, wherein the performing the Cat 2 LBT comprises:
performing the Cat 2 LBT by the same beam.

6. The method of claim 4, wherein the all beams comprise a plurality of to-be-resumed beams, and the plurality of to-be-resumed beams comprise the same beam;
wherein the performing the Cat 2 LBT comprises:
performing the Cat 2 LBT by a beam covering the plurality of to-be-resumed beams; or
performing the Cat 2 LBT by each of the plurality of to-be-resumed beams.

7. The method of claim 3, wherein a beam of the first device for performing the Cat 2 LBT is the same as a beam of the first device for initiating a detection of the COT, and/or, a beam used by the first device for performing the Cat 2 LBT is determined by the first device.

8. The method of claim 1, wherein the two neighboring transmissions comprise two neighboring transmissions of the first device.

9. The method of claim 1, wherein the when a gap between two neighboring transmissions within COT is greater than or equal to a first gap, performing Cat 2 LBT before a last transmission of the two neighboring transmissions is performed, comprises:
if transmission within the COT is resumed by using the first gap, when the gap between the two neighboring transmissions is greater than or equal to the first gap, performing the Cat 2 LBT before the last transmission is performed.

10. The method of claim 9, further comprising:
if the transmission within the COT is not resumed by using the first gap, performing the last transmission within the COT.

11. A first device, comprising a processor, a memory and a transceiver,
wherein the memory is configured to store a computer program, and the processor is configured to call the transceiver to run the computer program stored in the memory, to perform operations of:
when a gap between two neighboring transmissions within Channel Occupancy Time (COT) is greater than or equal to a first gap, performing Category 2 Listen Before Talk (Cat 2 LBT) before a last transmission of the two neighboring transmissions is performed; wherein the first gap comprises a first maximum gap and/or a second maximum gap, the first maximum gap is a maximum gap, in which none of beams has data transmission, within the COT, and the second maximum gap is a maximum gap, in which one beam has no data transmission, within the COT; and
resuming the last transmission based on a performing result of the Cat 2 LBT.

12. The first device of claim 11, wherein the first gap comprises the first maximum gap;
wherein the when a gap between two neighboring transmissions within COT is greater than or equal to a first gap, performing Cat 2 LBT before a last transmission of the two neighboring transmissions is performed comprises:
when a second gap is greater than or equal to the first maximum gap, performing the Cat 2 LBT before the last transmission is performed; wherein the second gap is a gap, in which none of the beams has data transmission, between the two neighboring transmissions.

13. The first device of claim 12, wherein the performing the Cat 2 LBT comprises:
performing the Cat 2 LBT by a beam covering the all beams; or
performing the Cat 2 LBT by each of the all beams.

14. The first device of claim 11, wherein the two neighboring transmissions comprise two neighboring transmissions of the first device.

15. The first device of claim 11, wherein the when a gap between two neighboring transmissions within COT is greater than or equal to a first gap, performing Cat 2 LBT before a last transmission of the two neighboring transmissions is performed, comprises:
if transmission within the COT is resumed by using the first gap, when the gap between the two neighboring transmissions is greater than or equal to the first gap, performing the Cat 2 LBT before the last transmission is performed.

16. The first device of claim 15, further comprising:
if the transmission within the COT is not resumed by using the first gap, performing the last transmission within the COT.

17. A second device, comprising a processor, a memory and a transceiver,
wherein the memory is configured to store a computer program, and the processor is configured to call the transceiver to run the computer program stored in the memory, to perform operations of:
when a gap, which is between a transmission of a first device within Channel Occupancy Time (COT) and a transmission of the second device when the COT is shared, is greater than or equal to a second maximum gap, performing Category 2 Listen Before Talk (Cat 2 LBT) before the transmission of the second device is performed; wherein the transmission of the first device is a transmission on a beam, which corresponds to the second device, within the COT, and the second maximum gap is a maximum gap, in which one beam has no data transmission, within the COT; and
performing the transmission of the second device based on a performing result of the Cat 2 LBT.

18. The second device of claim 17, wherein the transmission of the first device is before the transmission of the second device;
wherein the when a gap, which is between a transmission of a first device within COT and a transmission of the second device when the COT is shared, is greater than or equal to a second maximum gap, performing Cat 2 LBT before the transmission of the second device is performed comprises:
when a gap between an end position of the transmission of the first device and a start position of the transmission of the second device is greater than or equal to the second maximum gap, performing the Cat 2 LBT before the transmission of the second device is performed.

19. The second device of claim 17, wherein the when a gap, which is between a transmission of a first device within COT and a transmission of the second device when the COT is shared, is greater than or equal to a second maximum gap, performing Cat 2 LBT before the transmission of the second device is performed comprises:
if the second maximum gap is used, when a gap between the transmission of the first device and the transmission of the second device is greater than or equal to the second maximum gap, performing the Cat 2 LBT before the transmission of the second device is performed.

20. The second device of claim 19, further comprising:
if the second maximum gap is not used, performing the transmission of the second device within the shared COT.
